(19) United States
(12) Patent Application Publication
(10) Pub. No.: US 2016/0189242 A1
(43) Pub. Date: Jun. 30, 2016

(54) FACILITATING ADVERTISER COMPETITION FOR PROVIDING COMPETING ADVERTISEMENTS

(71) Applicant: Yahoo!, Inc., Sunnyvale, CA (US)

(72) Inventors: Varun Bhagwan, San Jose, CA (US); Doug Sharp, San Francisco, CA (US)

(21) Appl. No.: 14/588,164

(22) Filed: Dec. 31, 2014

(51) Int. Cl. G06Q 30/02

(52) U.S. Cl. CPC G06Q 30/0275; G06Q 30/0243

(57) ABSTRACT

Users may receive content (e.g., an email, an app interface, a website, a social media post, etc.) comprising a first advertisement. The first advertisement may be evaluated to extract advertisement features (e.g., an item, an item price, a supplemental term of the first advertisement, etc.). An advertisement opportunity may be offered to a second advertiser through an advertiser exchange interface. The second advertiser may generate an advertisement bid to show a second advertisement for the item. Responsive to the advertisement bid being more favorable to the user than the first advertisement (e.g., a lower price, the item with enhanced features for a similar price, etc.), the first advertisement and the second advertisement may be presented with the content to the user.

### BACKGROUND

Users may receive content comprising a promotional offer and/or an advertisement. For example, a user may receive an email comprising an advertisement for a bike at a price of $350 with shipping. The user may purchase the bike under the impression that the $350 price is a going rate for the bike. However, the $350 price may be relatively expensive compared to other bike shops that may offer the bike for a cheaper price, with enhanced features (e.g., a free bike rack, a kickstand, etc.), and/or with supplemental terms (e.g., free shipping). Thus, the user may be disappointed after purchasing the bike because the user was provided with an advertisement specifying a relatively bad deal.

### SUMMARY

In accordance with the present disclosure, one or more systems and/or methods for evaluating content (e.g., an email, an app interface, a website, a social media post, a text message, etc.) to identify a first advertisement associated with a first advertiser and/or a promotional offer associated with an entity, are provided. Advertisement features may be extracted from the first advertisement and/or the promotional offer. The advertisement features may comprise a description of an item for sale (e.g., a consumer good, such as a bike, a service such as bike repair, etc.), an item type of the item (e.g., a model or brand of the bike), an item price, a duration of the first advertisement (e.g., an ending date of a limited time offer), a supplemental term of the first advertisement (e.g., free shipping, tax already included, etc.), and/or an item availability of the item provided by the first advertisement (e.g., “only 3 bikes left”, which may indicate that no bikes may be available for purchase by the time a user receives the advertisement). Textual recognition and/or image recognition may be performed on the first advertisement and/or the promotional offer to identify the item.

An advertisement opportunity may be generated based upon the advertisement features. The advertisement opportunity may be offered to a second advertiser by exposing an advertiser exchange interface to a second advertiser (e.g., a bidding user interface where advertisers may be offered advertisement opportunities and where advertisers may submit bids to purchase the ability to show advertisements through such advertisement opportunities). The advertiser exchange interface may be populated with the advertisement opportunity. An advertisement bid may be received through the advertiser exchange interface. In an example, the first advertiser and/or the entity may pay for a competition block so that the advertisement opportunity is not offered to other advertisers such as the second advertiser.

The advertisement bid may be evaluated to determine whether the advertisement bid exceeds an advertisement competition threshold. In an example, the advertisement bid may exceed the advertisement competition threshold based upon the advertisement bid corresponding to a second item comprising a feature that is not comprised by the item (e.g., an upgraded model of the bike for a similar price). In an example, the advertisement bid may exceed the advertisement competition threshold based upon the advertisement bid correspond to a second item price that is equal to or less than the item price of the bike. In an example, the advertisement bid may exceed the advertisement competition threshold based upon the second item price being within a price threshold of the item price (e.g., a +/−10% threshold) and the second advertiser having a second favored advertiser metric greater than a first favored advertiser metric of the first advertiser (e.g., the second advertiser may be a well-known and reputable store, whereas the second advertiser may be a poorly rated store from which the user may be less likely to make a purchase).

Responsive to the advertisement bid exceeding the advertisement competition threshold with respect to the first advertisement and/or the promotional offer, a bid winner notification may be provided to the second advertiser through the advertiser exchange interface. Responsive to the advertisement bid not exceeding the advertisement competition threshold, a losing bid notification and/or a rebid opportunity may be provided to the second advertiser through the advertiser exchange interface.

Responsive to the advertisement bid exceeding the advertisement competition threshold, the second advertisement, the first advertisement, and/or the promotional offer may be provided with the content to a user (e.g., the second advertisement may be provided through an email interface that is displaying an email that comprises the first advertisement; the second advertisement may be inserted into the email with the first advertisement; etc.). User feedback may be obtained based upon whether the user selected the first advertisement, the promotional offer, and/or the second advertisement. The user feedback may be used to generate a monetization metric (e.g., a database comprising an amount of money a user is willing to pay for a particular item, item type, etc.) for the item and/or the item type associated with the first advertisement and/or the promotional offer.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of facilitating advertiser competition for providing competing advertisements.

FIG. 5A is a component block diagram illustrating an example system for facilitating advertiser competition for providing competing advertisements, where advertisement features are extracted.

FIG. 5B is a component block diagram illustrating an example system for facilitating advertiser competition for providing competing advertisements, where an advertisement bid exceeds an advertisement threshold.

FIG. 5C is a component block diagram illustrating an example system for facilitating advertiser competition for providing competing advertisements, where an advertisement bid does not exceed an advertisement threshold.

FIG. 6A is a component block diagram illustrating an example system for facilitating advertiser competition for providing competing advertisements, where advertisement features are extracted from a social network post.

FIG. 6B is a component block diagram illustrating an example system for facilitating advertiser competition for providing competing advertisements, where an advertisement bid exceeds an advertisement competition threshold based upon an item having enhanced features.

FIG. 7A is a component block diagram illustrating an example system for facilitating advertiser competition for providing competing advertisements, where advertisement features are extracted from a browser.

FIG. 7B is a component block diagram illustrating an example system for facilitating advertiser competition for providing competing advertisements, where an advertisement bid exceeds an advertisement competition threshold based upon an item price.

FIG. 8A is a component block diagram illustrating an example system for facilitating advertiser competition for providing competing advertisements, where advertisement features are extracted from an email.

FIG. 8B is a component block diagram illustrating an example system for facilitating advertiser competition for providing competing advertisements, where an advertisement bid exceeds an advertisement competition threshold based upon an item price.

FIG. 9 is a flow chart illustrating an example method of facilitating advertiser competition for providing competing advertisements.

FIG. 10 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

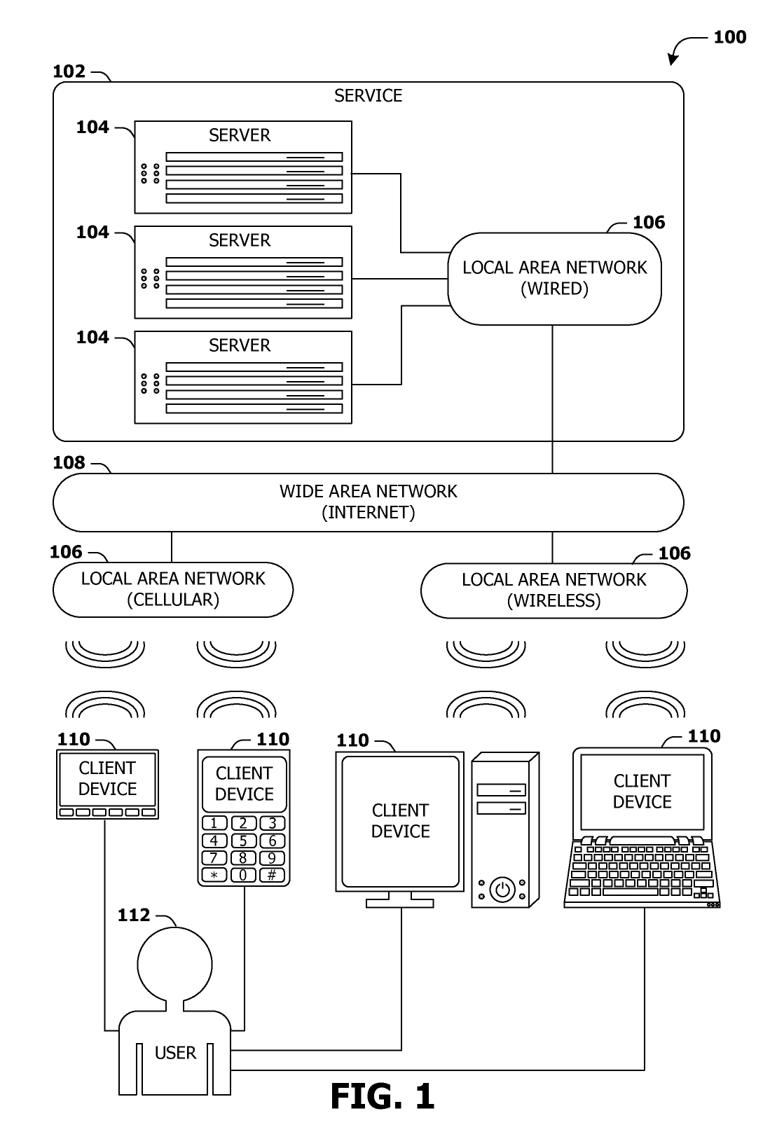

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

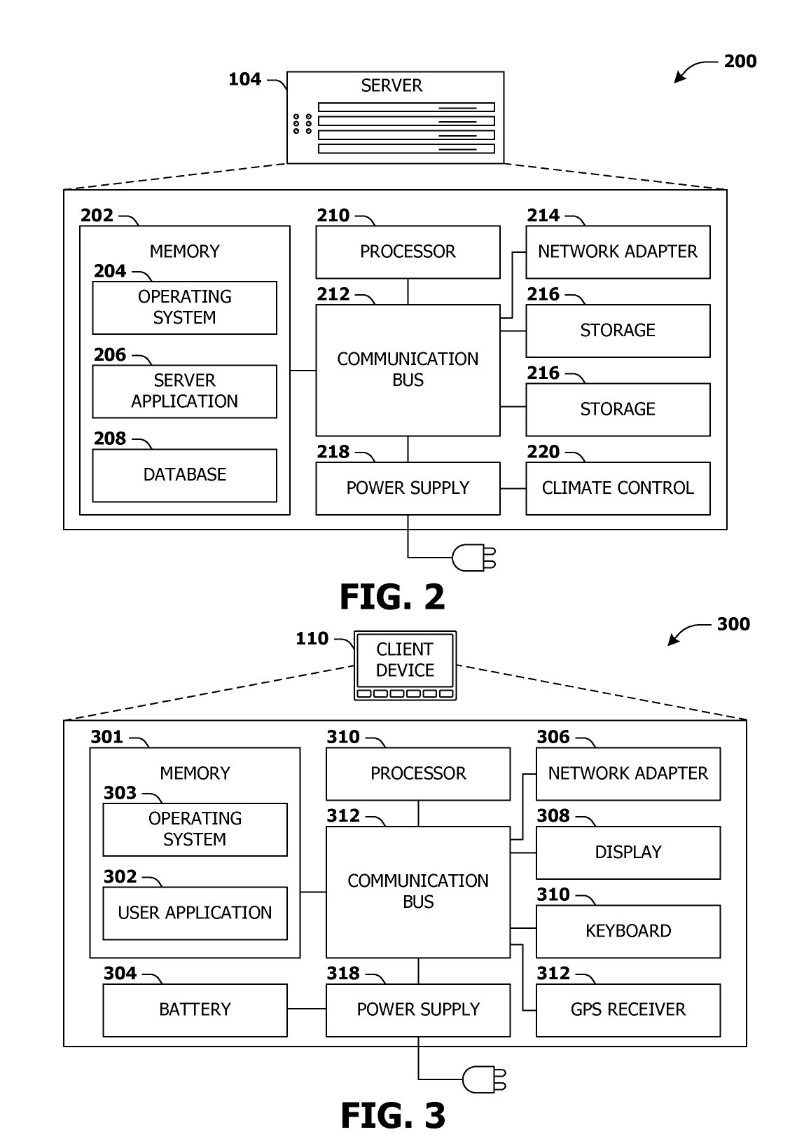

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques of facilitating advertiser competition for providing competing advertisements are provided. Users may receive content (e.g., an email, an app interface, a website, a social media post, a text message, etc.) comprising an advertisement. For example, a user may receive an email comprising an advertisement for a vacuum at a price of $200 before shipping. The user may purchase the vacuum under the impression that the $200 price is a going rate for the vacuum. However, the user may regret the purchase because the $200 price, along with $100 shipping, may be relatively expensive compared to other stores that may offer the vacuum for a cheaper price, with enhanced features (e.g., additional attachments), and/or with supplemental terms (e.g., free shipping). Thus, the user may be disappointed after purchasing the vacuum because the user was provided with an advertisement specifying a relatively bad deal.

Accordingly, as provided herein, content, such as an email comprising a first advertisement associated with a first advertiser and/or a promotional offer associated with an entity, may be evaluated by extracting advertisement features (e.g., an item price, an item, an item type of the item, a duration of the first advertisement, a supplemental term of the first advertisement, and/or an item availability of the item) to generate an advertisement opportunity. The advertisement opportunity may be provided to other advertisers, so that the other advertisers may have the opportunity to bid on a chance to show a second advertisement with the first advertisement and/or the promotional offer through the content (e.g., the email). The ability to provide users with competing advertisements may reduce network bandwidth, time, and/or computing resources otherwise utilized by users in an attempt to research and locate content, such as websites, that may offer the item at a competitive price (e.g., manually searching websites for advertisements or offers comprising an item of interest to the user). For example, if the item comprises the vacuum, then the user may search appliance websites, vacuum manufacturer websites, appliance shopping blogs and forums, social network posts, etc. in an attempt to identify a competitive price for the vacuum. Many content providers may not have information, processing resources, and/or network bandwidth to leverage one or more advertisers into bidding to provide the user with a favorable advertisement relevant to the item and/or the item type that the user desires. Thus, providing competitive advertisements to users may reduce resources and/or time otherwise wasted by such users researching for relevant pricing information.

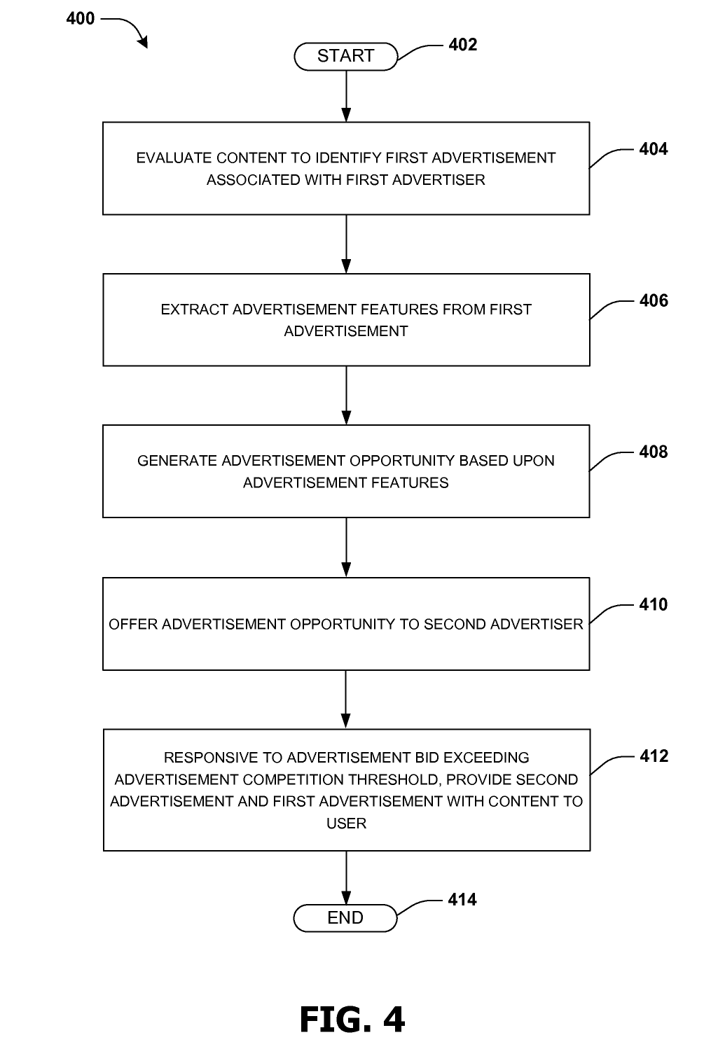

An embodiment of a method of facilitating advertiser competition for providing competing advertisements is illustrated by an example method 400 of FIG. 4. At 402, the method starts. A user, of a client device, may receive content (e.g., an email, an app interface, a website, a social media post, a text message, etc) comprising a first advertisement associated with a first advertiser (e.g., a business that sells items such as consumer goods or services). At 404, the content may be evaluated to identify the first advertisement associated with the first advertiser (e.g., a text parser, an HTML parser, and/or entity recognition functionality may be used to identify the advertisement).

The user may take affirmative action, such as providing opt-in consent, to allow access to and/or use of the content (e.g., social network posts, microblogs, videogame console usage, etc.), such as for the purpose of facilitating advertiser competition for providing competing advertisements (e.g., a lower price, enhanced features, free shipping, etc.).

At 406, advertisement features may be extracted from the first advertisement. The advertisement features may comprise an item (e.g., what item the advertisement is offering for sale), an item type (e.g., if the item comprises an Orange Laptop Computer, then the item type may be laptop), an item price, a duration of the first advertisement (e.g., 24 hours, a week, a month, etc.), supplemental terms of the first advertisement (free shipping, free installation, etc.), and/or an item availability of the item (e.g., is the item available in store, is the item on backorder, can the item be rain checked, etc.). Textual recognition and/or image recognition may be performed on the first advertisement to identify the advertisement features. The textual recognition may search for key item terms (e.g., computer, appliance, etc.), item numbers (e.g., numbers that identify the make and/or model of the item), item details (e.g., enhanced features offered with the item, such as increased storage and/or processing speed on a laptop), etc. The image recognition may identify the item from an image in the first advertisement.

At 408, an advertisement opportunity may be generated based upon the advertisement features. The advertisement opportunity may be associated with an advertiser exchange interface populated with the advertisement features and/or a bid option (e.g., an option for advertisers to submit an advertisement bid to compete with the first advertisement). In an example, the first advertiser may be offered an option to pay for a competition block. Responsive to the first advertiser selecting the option to pay for the competition block, the competition block may prevent an offering of the advertisement opportunity to a plurality of advertisers, such as a second advertiser.

At 410, the advertisement opportunity may be presented to the second advertiser (e.g., a business that sells the item). The advertisement opportunity may be presented to the plurality of advertisers (e.g., businesses that are registered with an advertisement exchange) through the advertiser exchange interface. The advertisement features may be used to generate an advertisement competition threshold (e.g., a threshold to exceed) to utilize the advertisement opportunity (e.g., a lower price, enhanced features, free shipping, an offer price within a price range threshold of the item price, a rating or confidence of users in an advertiser, etc.). The advertisers may submit advertiser bids for the advertisement opportunity through the advertiser exchange interface.

In an example, the second advertiser may submit an advertisement bid. In an example, the advertisement bid may exceed the advertisement competition threshold based upon the advertisement bid corresponding to a second item comprising a feature that is not comprised by the item (e.g., the advertisement bid may be for an upgraded model of the item provided by the first advertisement). For example, if the item is a Doughboy Couch without a recliner feature, then the second item may comprise the Doughboy Couch (or an equivalent couch) with the recliner feature. In another example, the advertisement bid may exceed the advertisement competition threshold based upon the advertisement bid corresponding to a second item price that is equal to or less than the item price (e.g., where the item price is $100 and the second item price is $90). In another example, the advertisement bid may exceed the advertisement competition threshold based upon the second item price being within a price threshold of the item price (e.g., the second item price may be within 10% of the item price) and the second advertiser having a second favored advertiser metric (e.g., users reviews, user ratings, business website rankings, social network posts, volume of sales, net worth, and/or other information may indicate that the second advertiser is generally regarded by users as trustworthy, a provider of high quality items, a provider that provides items in a timely manner, etc.) greater than a first favored advertiser metric of the first advertiser (e.g., the item price may be lower than the second item price, but the second advertiser is a well-known and trusted company, while the first advertiser is a small unknown company).

Responsive to the advertisement bid exceeding the advertisement competition threshold with respect to the first advertisement, a bid winner notification may be provided to the second advertiser through the advertiser exchange interface. Responsive to the advertisement bid not exceeding the advertisement competition threshold, a losing bid notification and/or a rebid opportunity (e.g., the second advertiser may alter the terms of the advertisement bid and resubmit an altered advertisement bid) may be provided to the second advertiser through the advertiser exchange interface.

At 412, responsive to the second advertiser submitting the advertisement bid exceeding the advertisement competition threshold, the second advertisement and the first advertisement may be provided with the content to the user (e.g., if the first advertisement is comprised within an email, then the second advertisement may be populated within the email or through an email interface displaying the email). Responsive to the second advertiser submitting the advertisement bid below the advertisement competition threshold, merely the first advertisement may be provided with the content to the user. In this way, the user may choose whether to purchase the item (e.g., the Doughboy Couch) as presented by the first advertisement or the second item (e.g., such as the Doughboy Couch, or an equivalent couch, with the recliner feature) as presented by the second advertisement. User feedback may be obtained based upon whether the user selected the first advertisement or the second advertisement. The user feedback may be used to generate a monetization metric (e.g., a database entry comprising an amount of money a user is willing to pay for a particular item, item type, etc.) for the item and/or the item type. At 414, the method ends.

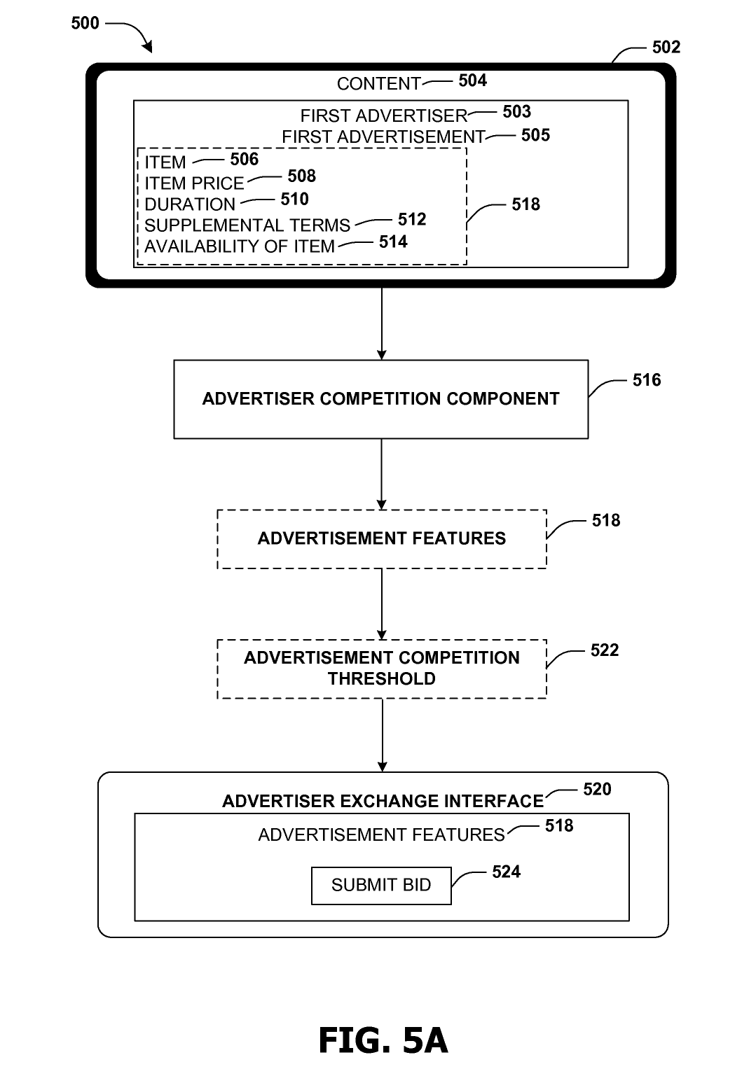

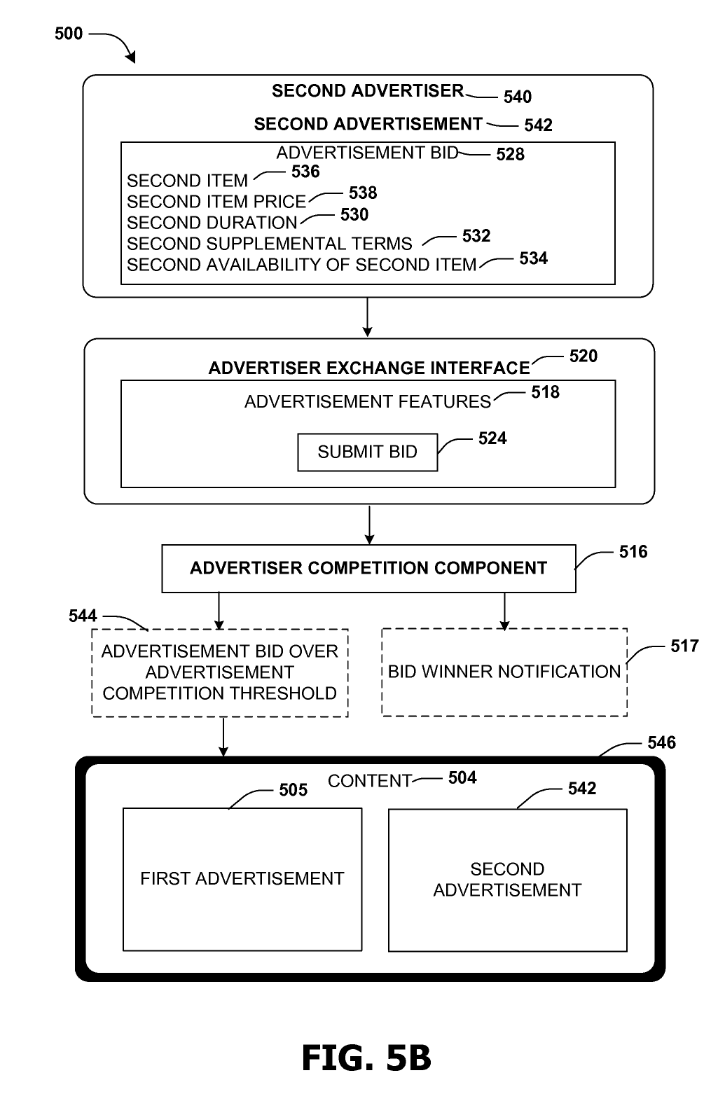

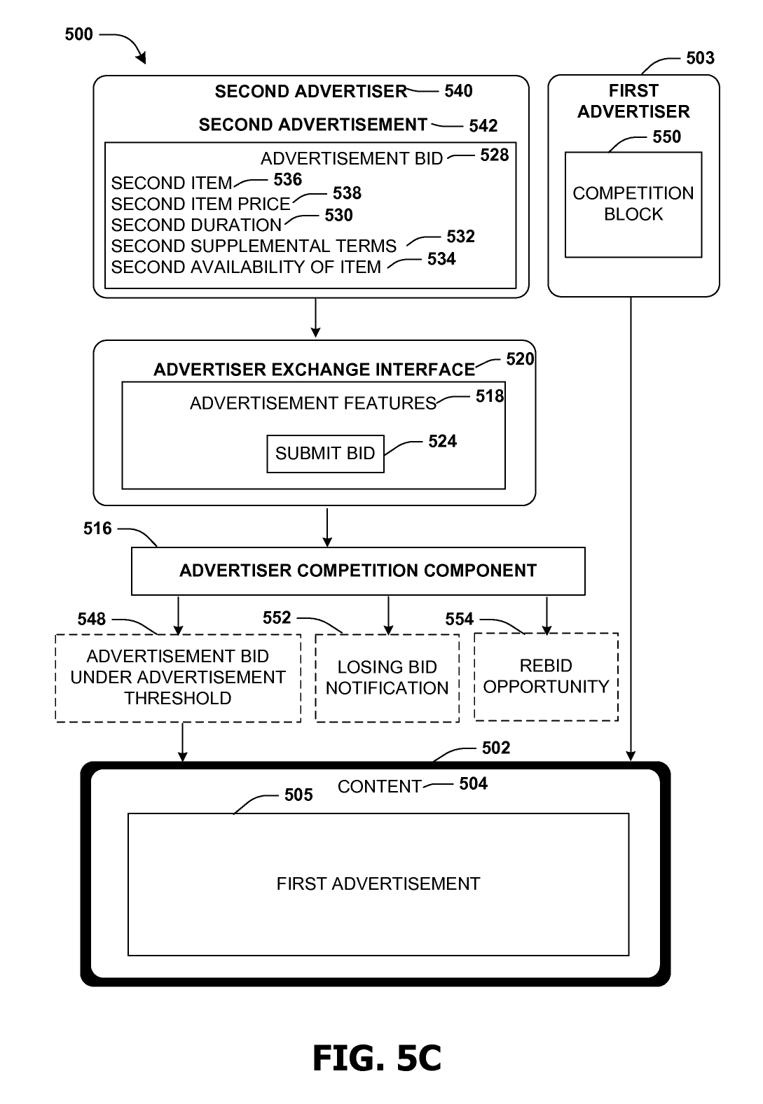

FIGS. 5A-5C illustrate an example of a system 500, comprising an advertiser competition component 516, for facilitating advertiser competition to provide competing advertisements. A user, of a client device 502, may be about to receive content 504 comprising a first advertisement 505 associated with a first advertiser 503. The first advertisement 505 may comprise advertisement features 518. The advertisement features 518 may comprise an item 506 (e.g., the item that the first advertisement 505 is offering for sale), an item price 508, a duration 510 of the advertisement (e.g., 24 hours, one week, etc.), supplemental terms 512 (e.g., free shipping, free installation, etc.), and/or an availability 514 of the item 506 (e.g., the item 506 may available in store, via shipping, on backorder, etc.).

The advertiser competition component 516 may extract the advertisement features 518 from the first advertisement 505. The advertiser competition component 516 may determine an advertisement competition threshold 522. The advertisement competition threshold 522 may comprise a threshold score. The threshold score may be determined by assigning a score to the advertisement features 518 and/or the first advertiser 503. In an example, the threshold score may be based upon a price score derived from a dollar amount of the item 506 (e.g., the threshold score may be increased as the price decreases relative to other competing price offers for the item 506). Thus, a relatively overpriced advertisement may be assigned a relatively lower threshold score such that advertisement bids may have a relatively greater likelihood to win (e.g., exceed the relatively lower threshold score) an opportunity to display a competitive advertisement with the relatively overpriced advertisement.

In an example, the threshold score may be based upon a duration score derived from the duration 510 (e.g., the longer the duration of the offer, the higher the duration score because the likelihood that the item 506 is still available at the item price 508 may be increased). In an example, the threshold score may be based upon a supplemental score derived from whether the supplemental terms 512 adds value to the user (e.g., free shipping may add value to the user, and thus the supplemental score may be increased based upon the free shipping, such as being based upon a value of the free shipping which may depend upon on a size of the item).

In an example, the threshold score may be based upon an availability score derived from the availability 514 of the item 506 (e.g., the item 506 may be more available based upon the item being available at a store near a location of the user or the item being available for immediate shipping). In an example, the threshold score may be based upon an advertiser score derived from a first favored advertiser metric corresponding to a trustworthiness, quality, and/or a value perception of users in regard to the first advertiser 503. In an example, if the first advertiser 503 comprises a small unknown company, then the advertiser score may be relatively lower than if the first advertiser 503 was a well known and highly rated company. The price score, the duration score, the supplemental score, the availability score, and/or the advertiser score may be combined to determine the threshold score for the advertisement competition threshold 522.

The advertisement features 518 and/or the advertisement competition threshold 522 may be input into an advertiser exchange interface 520. The advertiser exchange interface 520 may be populated with the advertisement features 518 and an option to submit 524 a bid.

FIGS. 5B-5C illustrate a second advertiser 540 imputing an advertisement bid 528 into the advertiser exchange interface 520. The second advertiser 540 may be offered an opportunity to submit the advertisement bid 528 to the advertiser exchange interface 520. In an example, the first advertiser 503 may be offered an opportunity to pay for a competition block 550, as illustrated in FIG. 5C. The selection of the competition block 550 by the first advertiser 502 may prevent an offering of the advertisement opportunity through the advertiser exchange interface 520. Responsive to the selection of the competition block 550 by the first advertiser 503, merely the first advertisement 505 may be presented with the content 504 to the user.

FIG. 5B illustrates the second advertiser 540 submitting the advertisement bid 528 to the advertiser exchange interface 520. Responsive to the second advertiser 540 successfully submitting the advertisement bid 528, the advertisement competition component 516 may provide the second advertiser 540 with a bid accepted notification (e.g., to confirm that the advertisement bid 528 was successfully input into the advertiser exchange interface 520). The advertisement bid 528 may comprise a second item 536 (e.g., the second item 536 may comprise the same item as the item 506 or may comprise a similar item such as an upgraded model with enhanced features), a second item price 538, a second duration 530 (e.g., 24 hours, a week, a month, etc.), second supplemental terms 532 (e.g., free shipping, free installation, etc.), and/or a second availability 534 of the second item 536 (e.g., the second item 536 may be available for in store pick-up, immediate delivery, on backorder, etc).

The advertiser competition component 516 may determine an advertisement bid score by assigning a score to the advertisement bid 528 and/or the second advertiser 540. For example, the advertisement bid score may be based upon a second price score derived from the second item price 538, a second duration score based upon the second duration 530, a second supplemental score based upon the second supplemental terms 532, a second availability score based upon the second availability 534 of the second item 536, and/or an advertiser score for the second advertiser 540. For example, the advertisement bid score may be increased the lower the second item price 538, the longer the second duration 530, the more beneficial the second supplemental terms 534, the more available the second item 536, and/or the better regarded the second advertiser 540.

Responsive to the advertisement bid 528 (e.g., the advertisement bid score) exceeding 544 the advertisement competition threshold 522 with respect to the first advertisement 505, a bid winner notification 517 may be provided to the second advertiser 540 through the advertiser exchange interface 520. The second advertisement 542 and the first advertisement 505 may be provided with the content 504 to the user (e.g., within the content 504 or within a user interface displaying the content 504).

FIG. 5C illustrates the advertisement bid 528 (e.g., the advertisement bid score) being below 548 the advertisement competition threshold 522 with respect to the first advertisement 505. Responsive to the advertisement bid 528 being below the advertisement competition threshold 522, a losing bid notification 552 and/or a rebid opportunity 554 may be provided to the second advertiser 540 through the advertiser exchange interface 520. In an example, the rebid opportunity 554 may provide the second advertiser 540 with an opportunity to alter the advertisement bid 528 to comprise an altered advertisement bid for resubmission to the advertiser exchange interface 520. The altered advertisement bid may be evaluated against the advertisement competition threshold 522. Responsive to the second advertiser 540 submitting the advertisement bid 528 below 548 the advertisement competition threshold 522, merely the first advertisement 505 may be provided within the content 504 to the user.

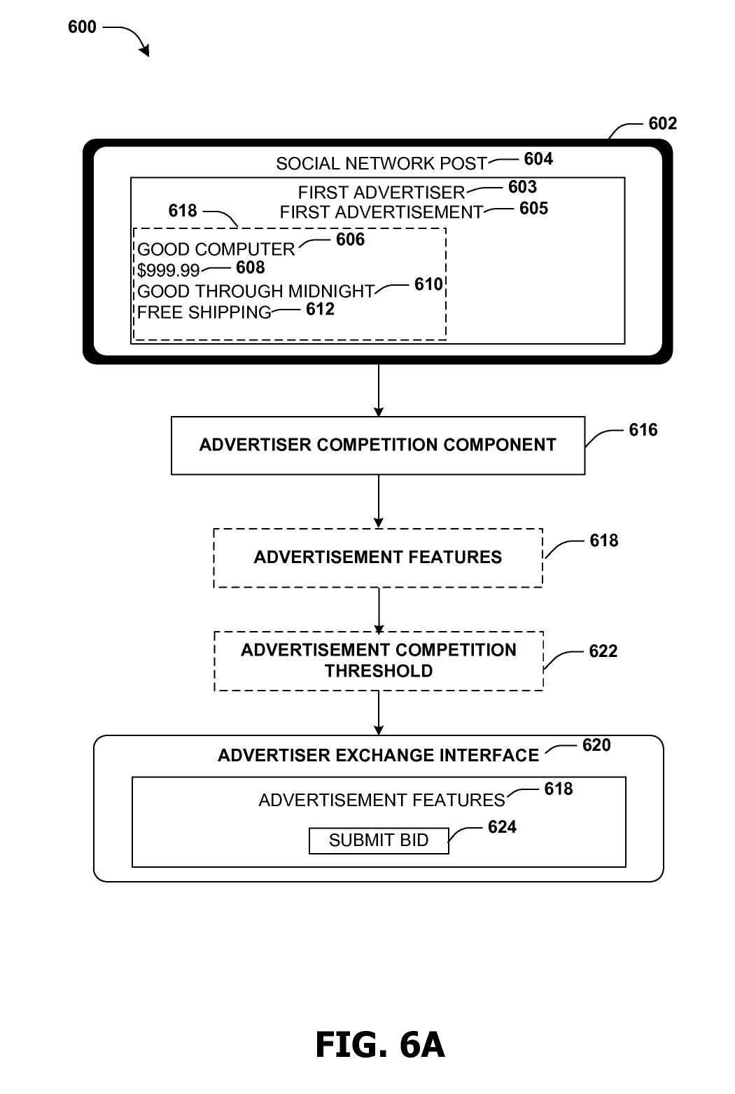

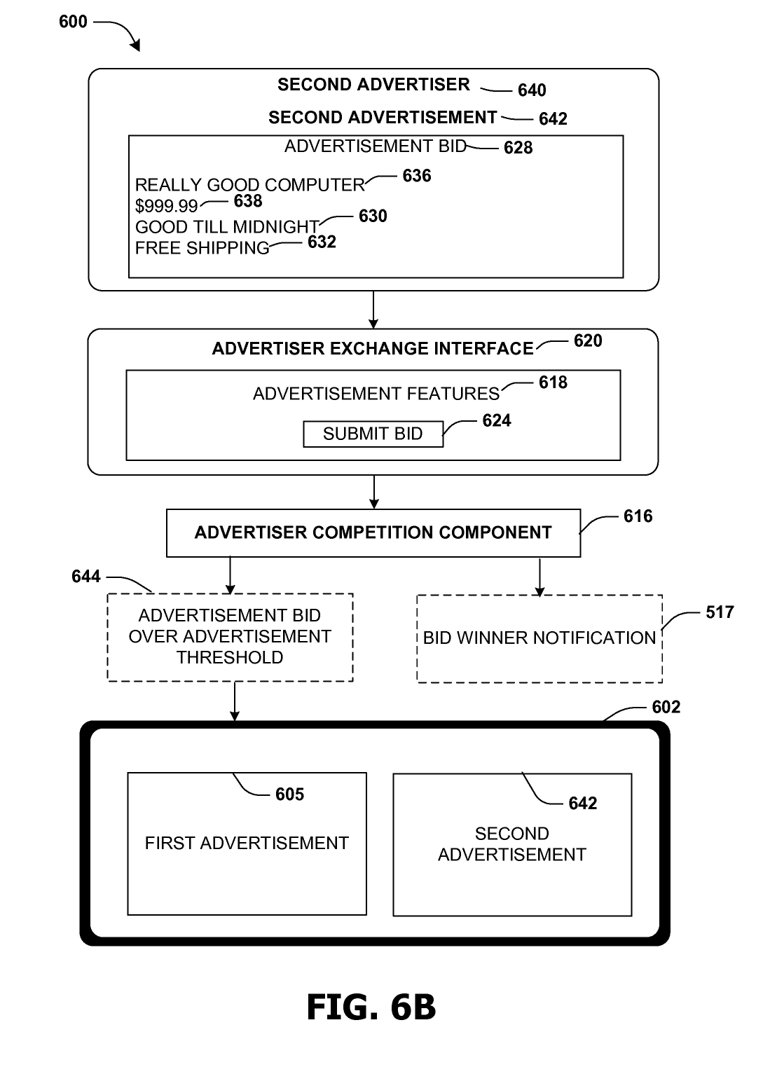

FIGS. 6A-6B illustrate an example of a system 600, comprising an advertiser competition component 616, for facilitating advertiser competition to provide competing advertisements. A user, of a client device 602, may be about to receive a social network post 604 comprising a first advertisement 605 associated with a first advertiser 603. The first advertisement 605 may comprise advertisement features 618. The advertisement features 618 may comprise a Good Computer 606 that is for sale at a $999.99 price 608, where the first advertisement 605 is valid until midnight 610 on the day the first advertisement is sent and the Good Computer 606 may be shipped for free 612.

The advertiser competition component 616 may extract the advertisement features 618 from the first advertisement 605. The advertiser competition component 616 may determine an advertisement competition threshold 622 based upon the advertisement features 618. The advertisement competition threshold 622 may be increased (e.g., based upon an item price score) because the $999.99 price 608 is a relatively competitive price (e.g., shopping websites may be crawled to identify a trending price for the Good Computer 606). The advertisement competition threshold 622 may be decreased (e.g., based upon a duration score) because the first advertisement 604 expires in less than 24 hours. The advertisement threshold 622 may be increased (e.g., based upon a supplemental score) because of the free shipping 612. The advertisement threshold 622 may be decreased (e.g., based upon an advertiser score) because the first advertiser 603 may be a small unknown company that may be unreliable. The advertisement features 618 and/or the advertisement competition threshold 622 may be input into an advertiser exchange interface 620. The advertiser exchange interface 620 may be populated with the advertisement features 618 and/or an option to submit 624 a bid.

FIG. 6B illustrates a second advertiser 640 imputing an advertisement bid 628 into the advertiser exchange interface 620. The advertisement bid 628 may comprise a Really Good Computer 636 (e.g., the Really Good Computer 636 may comprise the Good Computer 606 with enhanced features, such as faster processing speeds, increased memory, larger screen size, etc.), a $999.99 price 638 for the Really Good Computer 636, where the second advertisement 642 is valid until midnight 630 on the day the second advertisement 642 is sent and the Really Good Computer 636 may be shipped for free 632.

The advertiser competition component 616 may determine an advertisement bid score by assigning a score to the advertisement bid 628 and/or the second advertiser 640. For example, the advertisement bid score may be based upon a second price score derived from the $999.99 price 638, a second duration score based upon the midnight 630 duration, a second supplemental score based upon the free 632 shipping, and/or an advertiser score for the second advertiser 640.

Responsive to the advertiser competition component 616 determining that the advertisement bid score exceeds 644 the advertisement competition threshold 622, a bid winner notification 517 may be sent to the second advertiser 640, and the first advertisement 605 and the second advertisement 642 may be presented to the user.

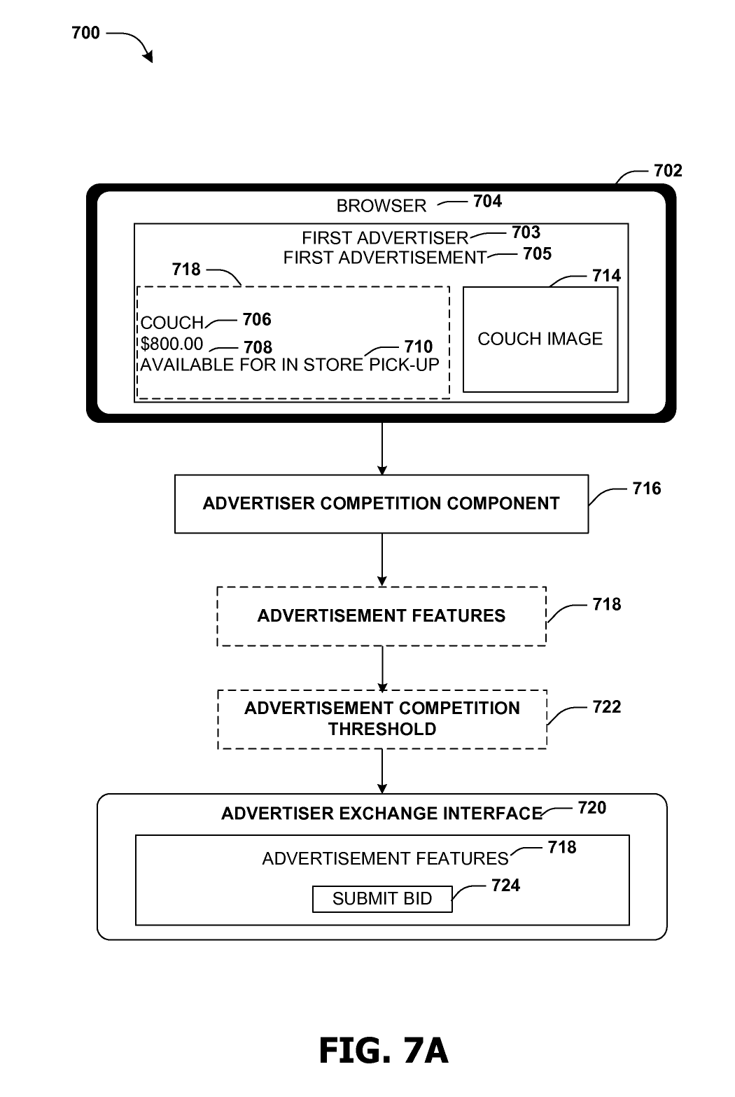

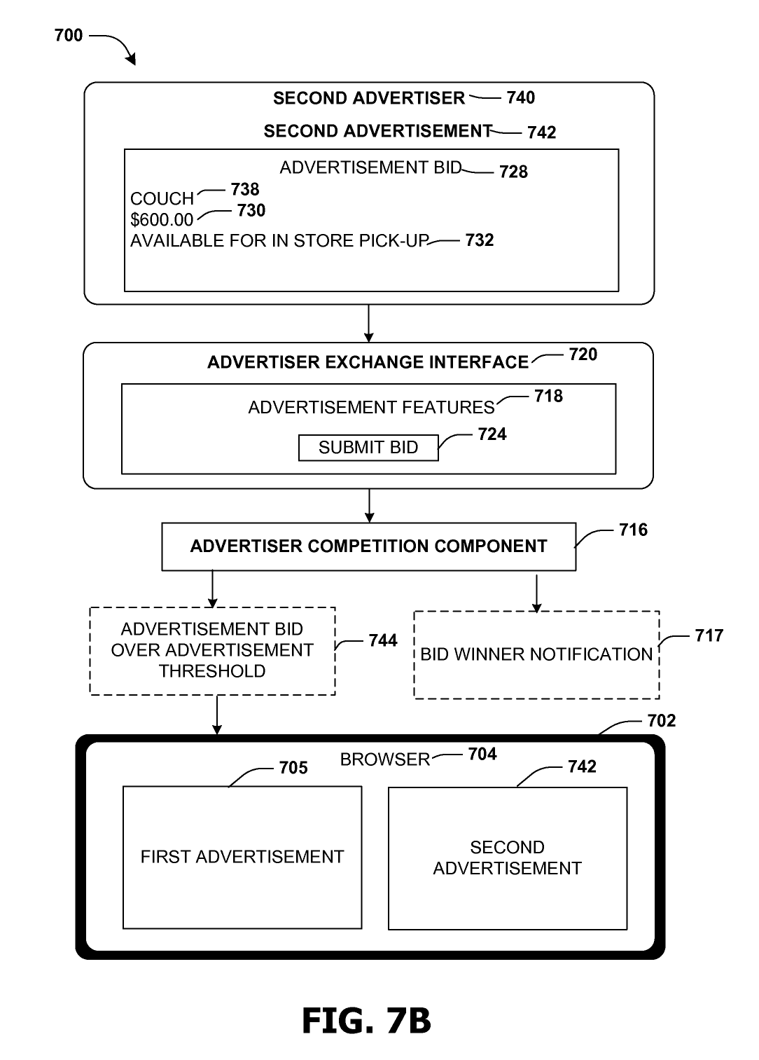

FIGS. 7A-7B illustrate an example of a system 700, comprising an advertiser competition component 716, for facilitating advertiser competition to provide competing advertisements. A user, of a client device 702, may be utilizing a browser 704 that is used to display a first advertisement 705 associated with a first advertiser 703. The first advertisement 705 may comprise a couch image 714 and/or advertisement features 718. The advertisement features 718 may comprise a couch 706 offered at a $800.00 price 708, and the couch 706 may be available for in store pick-up 710.

The advertiser competition component 716 may extract the advertisement features 718 from the first advertisement 705. The advertiser competition component 716 may determine an advertisement competition threshold 722 by assigning a score to the advertisement features 718 and/or the first advertiser 703. The advertisement competition threshold 722 may be decreased (e.g., based upon an item price score) because the $800.00 price 708 is a relatively expensive price (e.g., shopping websites may be crawled to identify a trending price for couch 706). The advertisement competition threshold 722 may be increased (e.g., based upon a supplemental score) because of the couch 706 is available for local store pick-up 710. The advertisement threshold 722 may be decreased (e.g., based upon an advertiser score) because the first advertiser 703 may be a small unknown company that may be unreliable.

The advertisement features 718 and/or the advertisement competition threshold 722 may be input into an advertiser exchange interface 720. The advertiser exchange interface 720 may be populated with the advertisement features 718 and an option to submit 724 a bid.

FIG. 7B illustrates a second advertiser 740 imputing an advertisement bid 728 into the advertiser exchange interface 720. The advertisement bid 728 may comprise a couch 738 (e.g., the same couch as the couch 706) offered for sale at a $600.00 price 730, and the couch 738 may be available for in store pick-up 732.

The advertiser competition component 716 may determine an advertisement bid score by assigning a score to the advertisement bid 728 and/or the second advertiser 740. For example, the advertisement bid score may be based upon a second price score derived from the $600.00 price 730, a second supplemental score based upon the local in store pick-up 732, and/or an advertiser score for the second advertiser 740.

Responsive to the advertiser competition component 716 determining that the advertisement bid score exceeds 744 the advertisement competition threshold 722, a bid winner notification 717 may be sent to the second advertiser 740, and the first advertisement 705 and the second advertisement 742 may be presented to the user through the browser 704.

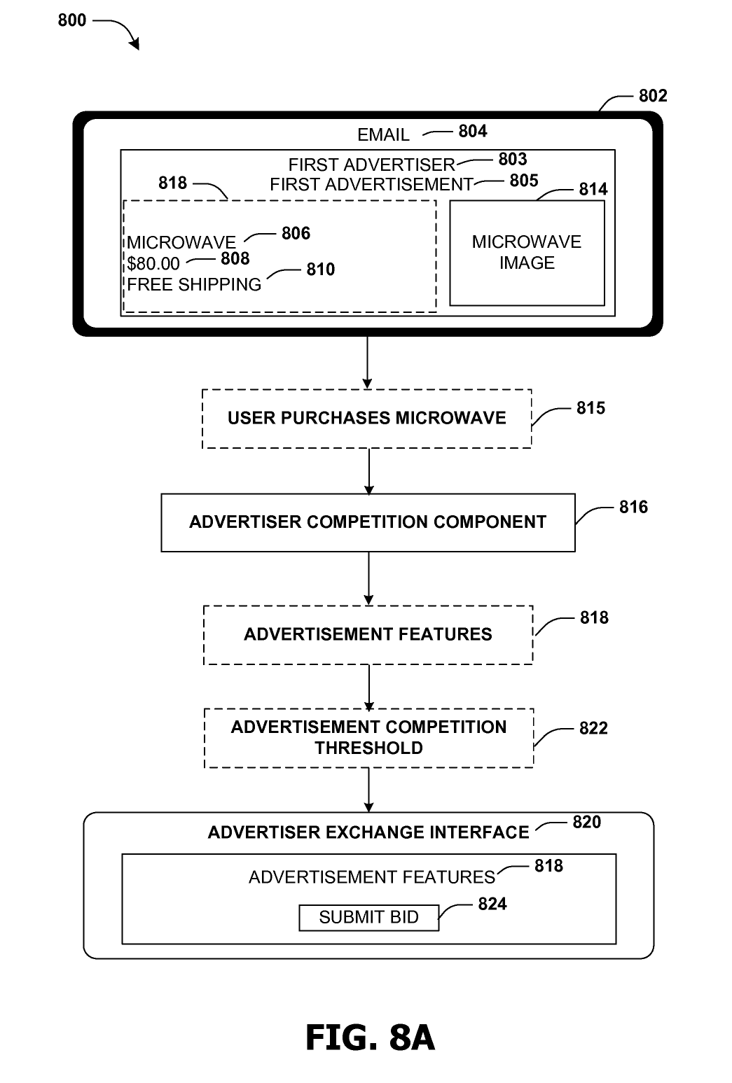

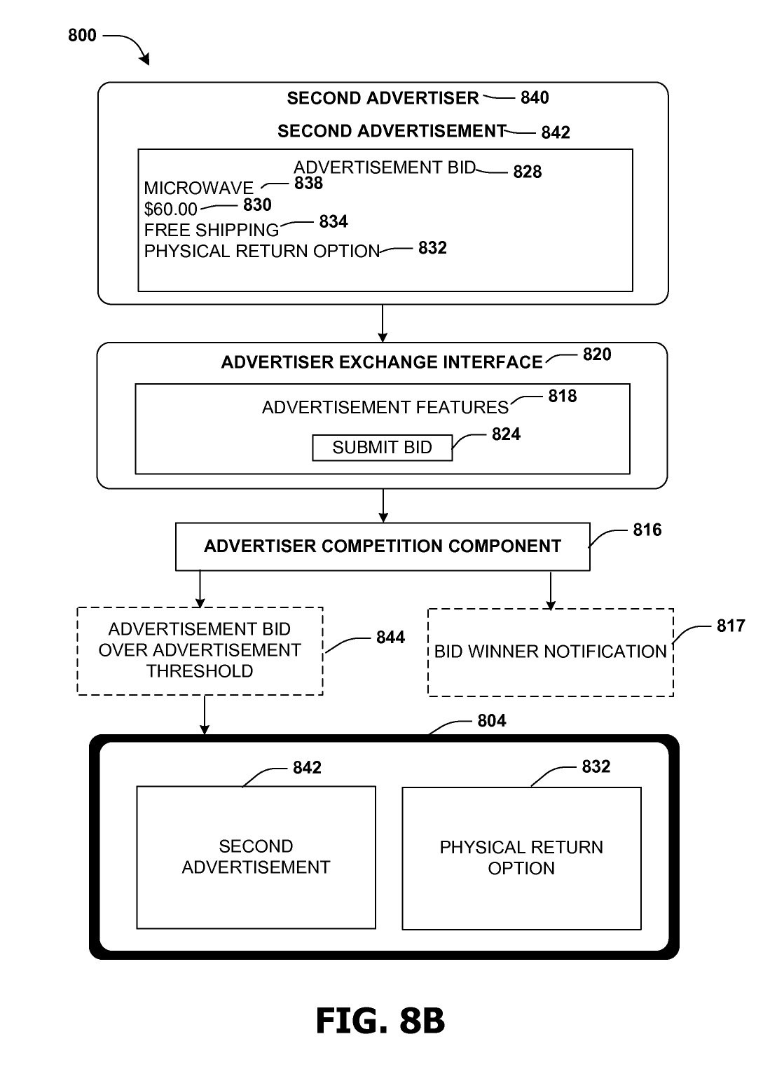

FIGS. 8A-8B illustrate an example of a system 800, comprising an advertiser competition component 816, for facilitating advertiser competition to provide competing advertisements. A user, of a client device 802, may receive an email 804 comprising a first advertisement 805 associated with a first advertiser 803. The first advertisement 805 may comprise a microwave image 814. The first advertisement 805 may comprise advertisement features 818. The advertisement features 818 may comprise a microwave 806 offered for a $80.00 price 808, and the microwave 806 may be shipped for free 810. The user may purchase 815 the microwave 806 as provided by the first advertiser 803 in the first advertisement 805.

The advertiser competition component 816 may extract the advertisement features 818 from the first advertisement 805. The advertiser competition component 816 may determine an advertisement competition threshold 822 based upon the advertisement features. The advertisement features 818 and/or the advertisement competition threshold 822 may be input into an advertiser exchange interface 820. The advertiser exchange interface 820 may be populated with the advertisement features and an option to submit 824 a bid.

FIG. 8B illustrates the second advertiser 840 imputing an advertisement bid 828 into the advertiser exchange interface 820. The advertisement bid 828 may comprise a microwave 838 (e.g., the microwave 838 may be the same as the microwave 806), a $60.00 price 830, free shipping 834 for the microwave 838, and a physical return option 832 (e.g., an option for the user to return the purchased 815 microwave 806, such as within a shipping container with postage or an option to take the microwave 806 to a store for return). In an example, if an item comprises digital content (e.g., a digital movie, a digital book, a digital video game, etc.), then the advertisement bid 828 may comprise an electronic return option. The electronic return option may direct the user to a webpage where the digital content may be returned.

The advertiser competition component 816 may determine an advertisement bid score based on the advertisement bid 828. Responsive to the advertiser competition component 816 determining that the advertisement bid score exceeds 844 the advertisement competition threshold 822, a bid winner notification 817 may be sent to the second advertiser 840, and the second advertisement 842 and the physical return option 832 may be presented to the user through a browser 804.

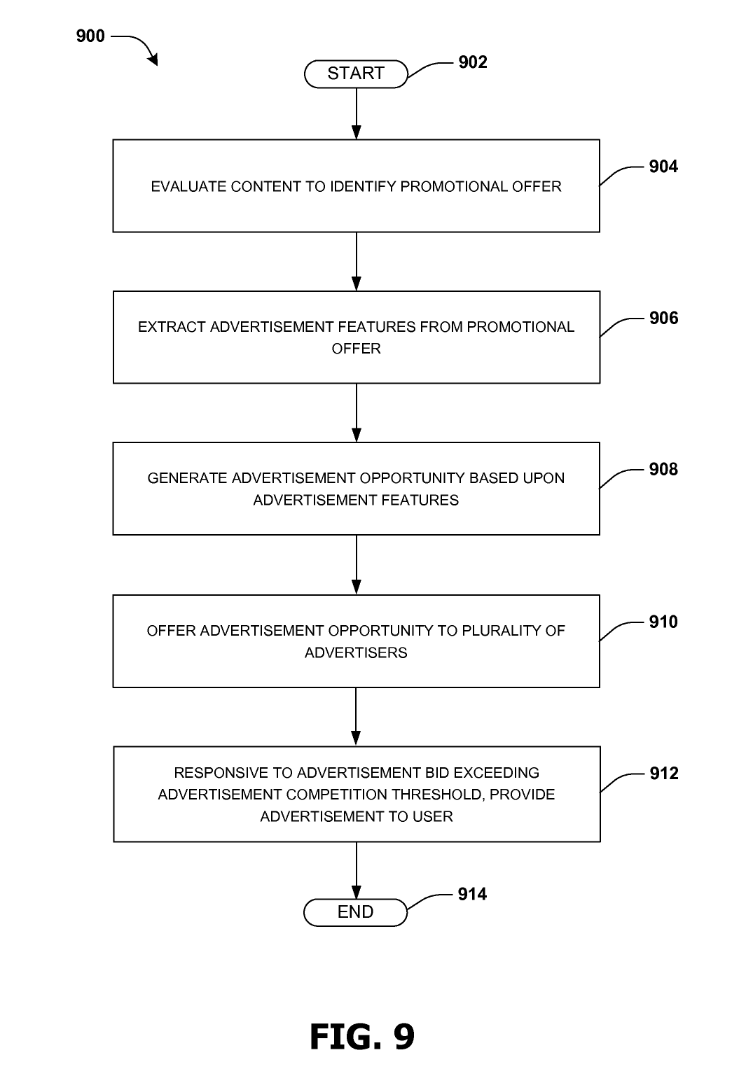

An embodiment of a method of facilitating advertiser competition for providing competing advertisements is illustrated by an example method 900 of FIG. 9. At 902, the method starts. A user, of a client device, may receive content comprising a promotional offer (e.g., a promotional email and/or newsletter from a store with a promotional offer on an item) from an entity (e.g., a company selling the item).

At 904, the content may be evaluated to identify the promotional offer associated with the entity (e.g., a text parser, an HTML parser, and/or entity recognition functionality may be used to identify the promotional offer).

At 906, advertisement features may be extracted from the promotional offer. The advertisement features may comprise an item, an item type, an item price, a duration of the promotional offer, supplemental terms of the first advertisement, and/or an item availability of the item.

At 908, an advertisement opportunity may be generated based upon the advertisement features. The advertisement opportunity may be associated with an advertiser exchange interface populated with the advertisement features and/or a bid option. In an example, the entity may be offered an option to pay for a competition block. Responsive to the entity selecting the option to pay for the competition block, the competition block may prevent an offering of the advertisement opportunity to a plurality of advertisers, such as an advertiser.

At 910, the advertisement opportunity may be presented to a plurality of advertisers (e.g., such as the advertiser). The advertisement features may be used to generate an advertisement competition threshold to utilize the advertisement opportunity. The advertisers may submit advertiser bids for the advertisement opportunity through the advertiser exchange interface.

In an example, the advertiser may submit an advertisement bid. In an example, the advertisement bid may exceed the advertisement competition threshold based upon the advertisement bid corresponding to a second item comprising a feature that is not comprised by the item (e.g., the advertisement bid may be for an upgraded model of the item provided by the promotional offer). For example, if the item is a portable touch screen device offered for $200, then the second item may comprise the portable touch screen device with additional memory, processing speeds, and/or a bigger screen for $200.

In an example, the advertisement bid may exceed the advertisement competition threshold based upon the advertisement bid corresponding to the second item price being equal to or less than the item price. For example, if the item is the portable touch screen device offered for $50 off MSRP, then the second item may comprise the portable touch screen device for $75 off MSRP.

In an example, the advertisement bid may exceed the advertisement competition threshold based upon the second item price being within a price threshold of the item price and the advertiser having a second favored advertiser metric greater than a first favored advertiser metric of the entity. For example, if the entity is small unknown and/or disliked company having the first favored advertiser metric and the advertiser comprises a large well trusted company having the second favored advertiser metric (e.g. the second favored advertiser metric greater than the first favored advertiser metric), then the advertisement bid generated by the advertiser may offer the item a higher price but still exceed the advertisement competition threshold.

At 912, responsive to the advertiser submitting the advertisement bid exceeding the advertisement competition threshold, an advertisement (e.g., as provided by the advertiser) and the promotional offer may be provided with the content to the user. Responsive to the advertiser submitting the advertisement bid below the advertisement competition threshold, merely the promotional offer may be provided with the content to the user. User feedback may be obtained based upon whether the user selected the promotional offer or the advertisement. The user feedback may be used to generate a monetization metric for the item and/or the item type. At 914, the method ends.

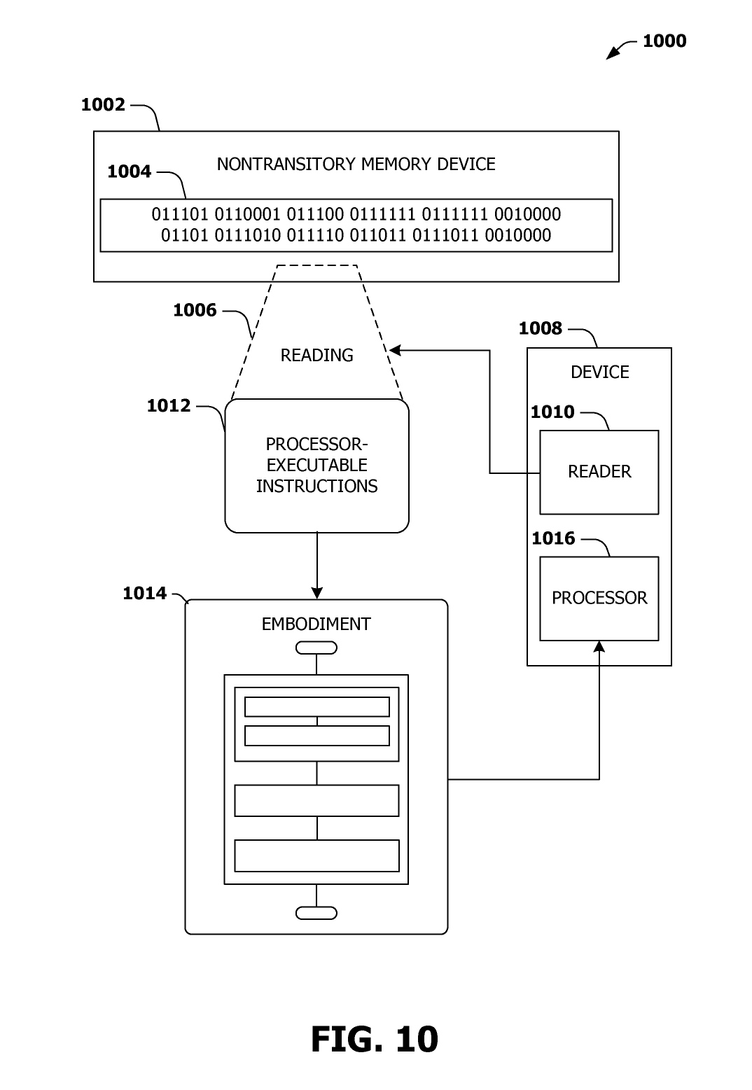

FIG. 10 is an illustration of a scenario 1000 involving an example nontransitory memory device 1002. The nontransitory memory device 1002 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 1002 stores computer-readable data 1004 that, when subjected to reading 1006 by a reader 1010 of a device 1008 (e.g., a read head of a hard disk drive, or a read operation invoked on a solid-state storage device), express processor-executable instructions 1012. In some embodiments, the processor-executable instructions, when executed on a processor 1016 of the device 1008, are configured to perform a method, such as at least some of the example method 400 of FIG. 4 and/or at least some of the example method 900 of FIG. 9, for example. In some embodiments, the processor-executable instructions, when executed on the processor 1016 of the device 1008, are configured to implement a system, such as at least some of the example system 500 of FIGS. 5A-5C, at least some of the example system 600 of FIGS. 6A-6B, at least some of the example system 700 of FIGS. 7A-7B, and/or at least some of the example system 800 of FIGS. 8A-8B, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for facilitating advertiser competition for providing competing advertisements, comprising:
evaluating content to identify a first advertisement associated with a first advertiser;
extracting advertisement features from the first advertisement;
generating an advertisement opportunity based upon the advertisement features;
offering the advertisement opportunity to a second advertiser; and
responsive to the second advertiser submitting an advertisement bid exceeding an advertisement competition threshold with respect to the first advertisement, providing the second advertisement and the first advertisement with the content to a user.

2. The method of claim 1, the extracting comprising:
obtaining an item type and an item price as the advertisement features.

3. The method of claim 2, comprising:
determining that the advertisement bid exceeds the advertisement competition threshold based upon the advertisement bid corresponding to at least one of:
a second item type comprising a feature that is not comprised by the item type;
a second item price that is equal to or less than the item price; or
the second item price that is within a price threshold of the item price and the second advertiser having a second favored advertiser metric greater than a first favored advertiser metric of the first advertiser.

4. The method of claim 1, the extracting comprising:
performing at least one of textual recognition or image recognition on the first advertisement.

5. The method of claim 1, comprising:
responsive to a determination that the first advertiser paid for a competition block, refraining from offering the advertisement opportunity to the second advertiser.

6. The method of claim 1, comprising:
obtaining user feedback based upon whether the user selected the first advertisement or the second advertisement.

7. The method of claim 6, comprising:
utilizing the user feedback to generate a monetization metric for an item type associated with the first advertisement.

8. The method of claim 1, the generating comprising:
exposing an advertiser exchange interface to a plurality of advertisers;
populating the advertiser exchange interface with the advertisement opportunity; and
receiving one or more advertisement bids through the advertiser exchange interface.

9. The method of claim 8, comprising:
responsive to accepting the advertisement bid, providing a bid accepted notification to the second advertiser through the advertiser exchange interface.

10. The method of claim 8, comprising:
responsive to the advertisement bid exceeding an advertisement competition threshold with respect to the first advertisement and the one or more advertisement bids received through the advertiser exchange interface, providing a bid winner notification to the second advertiser through the advertiser exchange interface.

11. The method of claim 8, responsive to the advertisement bid not exceeding an advertisement competition threshold with respect to the first advertisement and the one or more advertisement bids received through the advertiser exchange interface, providing at least one of a losing bid notification or a rebid opportunity to the second advertiser through the advertiser exchange interface.

12. The method of claim 1, the extracting comprising:
obtaining at least one of a duration of the first advertisement, a supplemental term of the first advertisement, or an item availability of an item provided by the first advertisement as the advertisement features.

13. The method of claim 1, the content comprising at least one of:
an email;
an app interface;
a website;
a social media post; or
a text message.

14. The method of claim 1, the second advertisement provided to the user, and the method comprising:
responsive to the user purchasing an item from the first advertiser, providing at least one of:
an electronic return option to return the item to the first advertiser;
a purchase option to purchase the item from the second advertiser; or
a physical return option to receive a shipping container for returning the item to the first advertisers.

15. A non-transitory computer readable medium comprising computer executable instructions that when executed by a processor perform a method for facilitating advertiser competition for providing competing advertisements, comprising:
evaluating content to identify a promotional offer associated with an entity;
extracting advertisement features from the promotional offer;
generating an advertisement opportunity based upon the advertisement features;
offering the advertisement opportunity to a plurality of advertisers through the advertiser exchange interface; and
responsive to an advertiser submitting an advertisement bid exceeding an advertisement competition threshold with respect to the promotional offer, providing the advertisement to a user.

16. The method of claim 15, the extracting comprising:
obtaining an item type and an item price as the advertisement features.

17. The method of claim 16, comprising:
determining that the advertisement bid exceeds the advertisement competition threshold based upon the advertisement bid corresponding to at least one of:
a second item type comprising a feature that is not comprised by the item type;
a second item price that is equal to or less than the item price; or
the second item price that is within a price threshold of the item price and the advertiser having a second favored advertiser metric greater than a first favored advertiser metric of the entity.

18. The method of claim 15, comprising:
responsive to a determination that the entity paid for a competition block, refraining from offering the opportunity to the advertiser.

19. A system for facilitating advertiser competition for providing competing advertisements, comprising:
an advertiser competition component configured to:
evaluate content to identify a first advertisement associated with a first advertiser;
extract advertisement features from the first advertisement;
generate an advertisement opportunity based upon the advertisement features;
offer the first advertiser a competition block to prevent the advertisement opportunity from being offered to a second advertiser;
responsive to the first advertiser not utilizing the competition block, offer the advertisement opportunity to a second advertiser; and
responsive to the second advertiser submitting an advertisement bid exceeding an advertisement competition threshold with respect to the first advertisement, provide the second advertisement and the first advertisement with the content to a user.

20. The system of claim 19, responsive to the first advertiser utilizing the competition block, refrain from offering the advertisement opportunity to the second advertiser.
